(19) United States
(12) Patent Application Publication
(10) Pub. No.: US 2004/0047424 A1
(43) Pub. Date: Mar. 11, 2004

(54) System and method for transmitting digital video files with error recovery

(76) Inventors: Kumar Ramaswamy, Plainsboro, NJ (US); Andrew Denys Hackett, Bourgbarre (FR)

Correspondence Address: Joseph S Tripoli, Thomson Multimedi Licensing Inc, P O Box 5312, Princeton, NJ, 08543-5312, US

(21) Appl. No.: 10/450,800

(22) PCT Filed: Oct. 15, 2002
(86) PCT No.: PCT/US02/32681

(51) Int. Cl. H04N 7/12

(52) U.S. Cl. 375/240.27

(57) ABSTRACT

A system and apparatus for assigning a sequential control packet (in a sequential series) to a group of MPEG-2 compliant program packets for error recovery of a media object. The invention parses the media object into a series of program packets (254, 256) for transmission via a transport stream. A control packet (252) is then inserted into the transport stream as to correspond to a quantity of program packets, where a counter (265) of the control packet (252) is sequentially numbered. An additional control packet (260) is interleaved in the transport stream after a second quantity of program packets are parsed. Optionally, the control packets are received by a receiving device that issues a command in response to missing control packet, when there is a gap in the sequential numbering of received control packets.

### FIELD OF THE INVENTION

The present invention relates to the transmission of digital audio and video files, specifically the error recovery of media objects of a length requiring transmission channel of a high bandwidth.

### BACKGROUND

With the growth in the satellite and cable industries, there has been significant interest in developing an architecture for delivering full-length movies to a home multimedia user. One concept of delivery called video on demand (VOD) provides a movie to a user based upon the selection that the user makes. The user may select programming via an electronic programming guide (EPG) that lists available media that may be received through a broadcast service. Once the movie is selected, the broadcast system would transmit the movie to the home user, the transmission either occurring through a cable means (such as a MPEG-2 digital cable transmission), a satellite broadcast (as DBS, DIRECTV™, DISH NETWORK™, etc.), a terrestrial broadcast (UHF, VHF, or broadcast channels for receiving standard definition/high definition programming, etc.), or twisted pair connection (such as DSL, etc.).

The complexity of transmitting a digital video (audio) file, hence forth referred to as a media object, requires that the transmission architecture be capable of handling digital video files of a large size. For instance, the requirements for a media object to be displayed at a “near to motion picture quality” (ex. High Definition Television), as a display format, requires that the transmission architecture requires the network support a throughput of nearly 20 Mbits/sec. The transmission architecture also has to have a low transmission error rate, as to not corrupt the requirements of the video/audio transmission. For instance, DBS satellite systems have to have error rates in the range from 10\hat{ }-9 to 10\hat{ }-11 bits to offer an acceptable quality of service (QOS).

The likelihood for an error corrupting the transmission of a media object is reduced if a media object is broken up into discrete segments. Such segments, known as data packets, separate the media object into individual divisions that are reconstituted at a receiving end of the transmission architecture. One used technique for packetizing data files complies with the MPEG-2 data-encoding standard to create a data stream (see MPEG-2 Specification ISO-13818-1) for encoding and transporting discrete data packets.

The requirements for transmitting the data packets at a relatively high bandwidth, as to display media, as a movie at an acceptable bit rate, does not leave much opportunity to fix corrupted media object transmission. Furthermore, when an error corrupts a media object transmission, the channel accommodating such a transmission does not have the luxury of rebroadcasting most segments of the corrupted video file because such a retransmission will prevent the transmission channel from accommodating the broadcast of other media objects.

### SUMMARY OF THE INVENTION

A system and method for assigning a sequential control packet to a group of program packets for error recovery via a back channel. The system rebroadcasts via a back channel missing program packets when the corresponding control packet is corrupted.

### BRIEF DESCRIPTION OF THE DRAWINGS

The above and other advantages and features of the present invention will be better understood from the following detailed description of the preferred embodiments of the invention, which is provided in connection with the accompanying drawings. The various features of the drawings may not be to scale. Included in the drawing are the following figures:

FIG. 1 is a block diagram of a transmission system in accordance with an exemplary embodiment of the present invention;

FIG. 2A is a diagram of a series of sequential control packets in accordance with an exemplary embodiment of the present invention utilizing the header of the series of sequential control packets;

FIG. 2B is a diagram of a series of sequential control packets in accordance with an exemplary embodiment of the present invention utilizing the payload of the series of sequential control packets;

FIG. 3 is a diagram of a MPEG based encoder in accordance with an exemplary embodiment of the present invention;

FIG. 4 is a diagram of an MPEG based decoder in accordance with an exemplary embodiment of the present invention.

### DETAILED DESCRIPTION

Although the invention is described in terms of exemplary embodiments, it is not limited thereto. Rather, the appended claims should be construed broadly, to include other variants and embodiments of the invention, which may be made by those skilled in the art without departing from the scope and range of equivalents of the invention.

The present invention is a system and method for transmitting and receiving audio, video, or a combination of both types of media as a media file or “media object”. As used herein, the term “media object” includes audio, video, textual, multimedia data files, and streaming media files. Multimedia objects comprise any combination of text, Image, video, and audio data. Streaming media comprises audio, video, multimedia, textual, and interactive data files that are delivered to a user via the Internet, satellite or other communications network environment and begin to play on the user's computer/device before delivery of the entire file is completed. Media objects may be transmitted over any communications network including via the Internet, satellite (DSS, DVB-S), cable, DSL, T1 lines, wireless network, or other delivery systems capable of delivering media objects.

Examples of the content of media objects include songs, political speeches, news broadcasts, movie trailers, movies, television show broadcasts, radio broadcasts, financial conference calls, live concerts, web-cam footage, and other special events. Media objects are encoded in various formats including REALAUDIO®, REALVIDEO®, REALMEDIA®, APPLE QUICKTIME®, MICROSOFT WINDOWS® MEDIA FORMAT, QUICKTIME®, MPEG-2 VIDEO COMPRESSION, MPEG-4 VIDEO AND/OR AUDIO COMPRESSION, JOINT VIDEO TEAM COMPRESSION FORMAT (MPEG-4 part 10 AVC, H.264), MPEG-2 LAYER III AUDIO, MP3®. Typically, media objects are designated with extensions (suffixes) indicating compatibility with specific formats. For example, media objects (e.g., audio and video files) ending in one of the extensions, ram, .rm, rpm, are compatible with the REALMEDIA® format. Some examples of file extensions and their compatible formats are listed in the Table 1. A more exhaustive list of media types, extensions and compatible formats may be found at http://www.bowers.cc/extensions2.htm.

TABLE 1

| Format | Extension |
|---|---|
| REALMEDIA ® | .ram, .rm, .rpm |
| APPLE QUICKTIME ® | .mov, .qif |
| MICROSOFT | .wma, .cmr, .avi |
| WINDOWS ® MEDIA | |
| PLAYER | |
| MACROMEDIA FLASH | .swf, .swl |
| MPEG | .mpg, .mpa, .mp1, |
| | .mp2 |
| MPEG-2 LAYER III | .mp3, .m3a, .m3u |
| Audio | |

The preferred embodiment of the invention operates with media objects that contain video data for presenting a video presentation of “near to motion picture quality”. The media object format comports to the MPEG-2 video compression and transport format, and DSS satellite broadcast scheme. One skilled in the art would be able to apply the teachings of the present invention to other media object formats, transport, and transmission schemes.

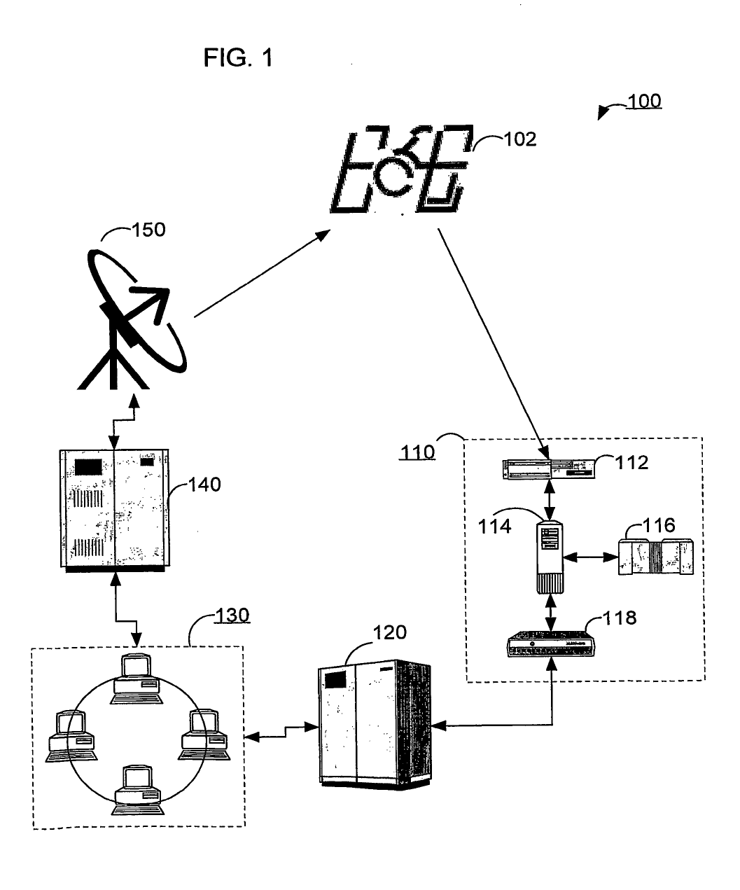

In FIG. 1, a transmission system in accordance with the present invention is shown. System 100 displays a preferred embodiment of a satellite based broadcast system for use of as an environment for the operation of the present invention. Satellite 102 acts as the central point for the transmission of a media object. Satellite 102 broadcasts a media object to receiver system 110. The satellite broadcast is preferably a DSS or DBS based satellite transmission (comporting to a satellite broadcast service as DIRECTV™, DISH NETWORK™, and the like). Receiver system 110 receives the broadcasted satellite signal containing a media object via an antenna connected to set top box receiver 112. The satellite signal encompasses data that comports to an MPEG-2 based transport stream and encoding scheme, as to be explained below in the specification. Set top box receiver 112 decodes and transfers the decoded satellite signal to processing unit 114 for processing.

Processing unit 114 represents the controller of receiver system 110. Aside from processing decoded broadcast signals, processing unit 114 also acts as a tuner, allowing for a user to select between different broadcast channels, as an Internet enabled device allowing for communications to and with other devices through a communications network (as the Internet or a phone network via modem 118), and as a means for displaying and/or outputting audio and video within a media object. Preferably, the processing unit 114 processes media objects as video to be displayed in a high definition format, although other video display formats are supported. Likewise, the audio processed by processing unit 114 preferably is Dolby Digital 5.1 or surround sound, although other audio formats are supported. Processing unit 114 also archives received media objects to storage device 116, such archived objects may be retrieved on demand (as a personal video recorder), and uses storage device 116 as auxiliary storage to process broadcast signals. Storage device 116 may be a hard drive, CD-ROM drive, Digital Video Disc Drive, floppy disc drive, or other known storage device capable of storing media objects.

Processing unit 114 also identifies errors in the received satellite signal. Such errors may be caused by interference with the received signal, missing data blocks, power outages, etc. When discovering an error in a transmission, processing unit 114 communicates with media server 130 to retransmit a segment of the media object, as explained below. Processing unit 114 utilizes a back channel established through modem 118 via a communications network as PSTN 120 (Phone Switched Telephone Network) to communicate with media server 130. Preferably, back channel is a high bandwidth connection as a DSL connection, although other types of communications networks may be used.

Media server 130 is the broadcast hub for transmitting media objects via satellite 102 to receiver 110. Preferably, media server 130 is a broadcast center, such as a television station or a radio station with the facilities to uplink media objects in the form of broadcast programming. Additionally, media server 130 may contain a series of media objects, as programming, that are delivered at designated times, or are requested on demand (as Video on Demand, etc), where media objects are stored on a plurality of storage devices (for example, as RAID III enabled hard drives having a capacity of Terabytes and/or Gigabytes) at media server 130 and transmitted via a uplink connection. Such media objects are recalled upon the needs of a broadcaster or home user.

Back end server 140 is coupled to media server 130, whereby back end server 140 enables the broadcast of media objects via uplink site 150. Back end server 140 may process a media object into a format compatible with a MPEG-2 transport and encoded data stream. Optionally, such processing is performed at media server 130, where back end server 140 receives the signal that needs to be transmitted to satellite 102. Additionally, back ender server 140 processes a media object into a packetized format, as explained below in the specification. Uplink site 150 operates with back end server 140 to transmit a media object as a satellite signal that is capable of being transmitted to receiver 110 via satellite 102.

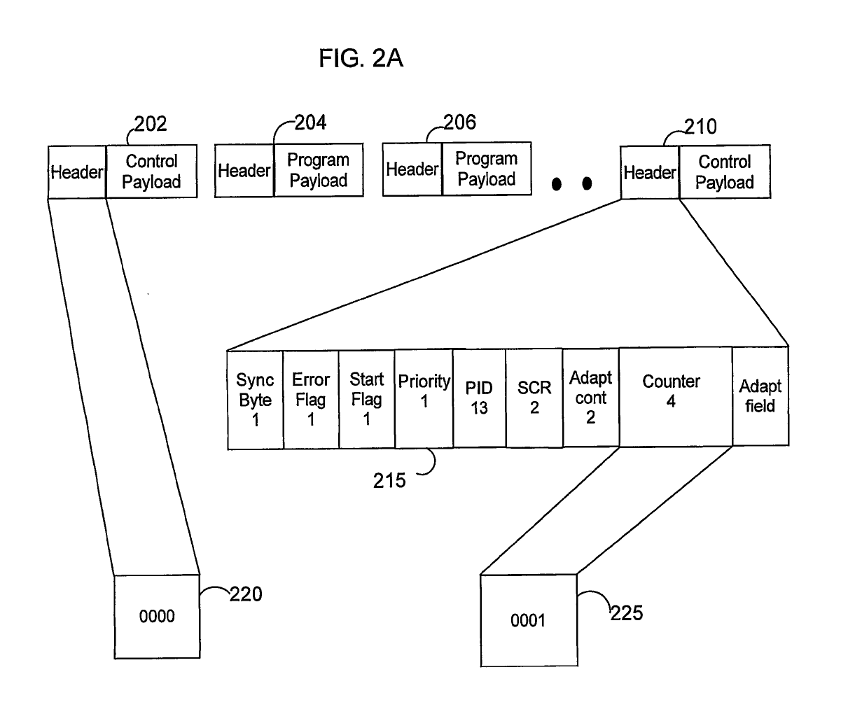

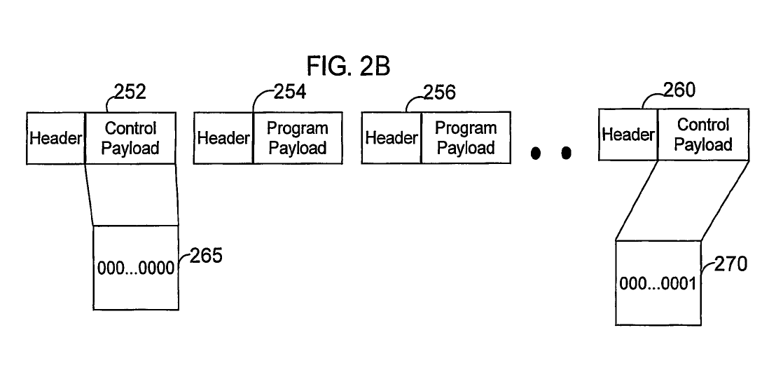

FIG. 2A is a diagram of a series of sequential control packets and program packets, as in accordance with the present invention. Specifically, FIG. 2A is an embodiment of a packetized MPEG-2 transport data stream with both control packets 202 and program packets 204, having a length of 188 bytes in the preferred embodiment of this invention, although other packets of other lengths are support by the principles of the present invention. Program packets 204 are the data segments of a media object that contains audio, video, or a combination of both types of data. Control packets 202 are inserted into a MPEG-2 data stream, at predetermined points, to segment the MPEG-2 transport data stream into discrete sections, of a predetermined quantity of program packets. This segmentation of program packets is done by an encoder at back end server 140, as shown in FIG. 3, below. Optionally, media server 130 parses a media object into program packets and control packets.

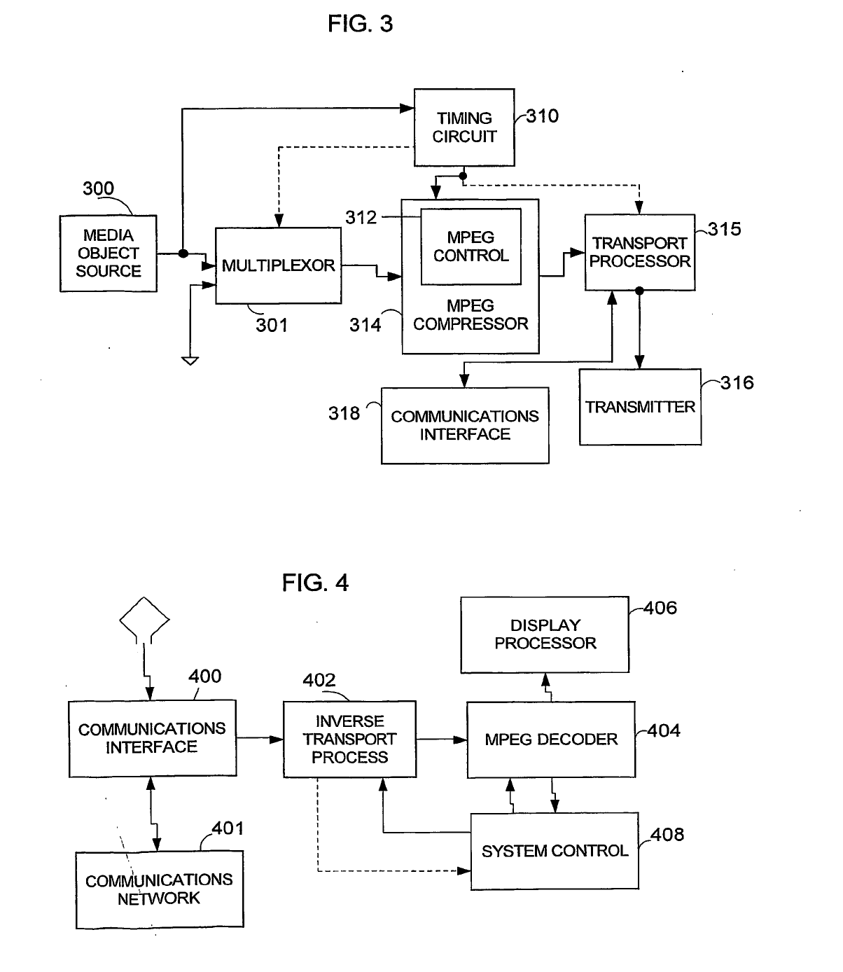

Both control packets 202 and program packets 204, the packets may be broken down into a header and a payload. Header 215 shows a typical breakdown of a typical MPEG-2 based packet. Each individual packet is typically Identified by a unique number known as a 13 bit packet identification code or PID, as representing in header 215. Typically, the PID is assigned when a media object is encoded and packetized into the MPEG-2 transport data stream via an encoder and transport processor, shown in FIG. 3, below. The MPEG-2 transport packets are then reassembled into a media object by demultiplexing received streams via their PID identification number as explained, in FIG. 4, below. The payload of program packet 204 contains audio, video, and/or a combination of both types of data comprising the media object, and auxiliary data. The payload of control packet 202 contains data related to a parsed media object, data related to being sequential counted, or other types of auxiliary data.

The current invention, aside for making use of PIDs, interleaves a control packet 202 with program packets 204 and 206 as to parse a media object into discrete segments of program packets, of a predefined number, headed by a control packet. Control packets advantageously allow the transmission architecture of the present invention to identify segments of a MPEG-2 transport data stream. When an transmission error occurs, the section in which the error occurs may be easily identified by receiver 110 as to inform back end server 140 via media server 130 which program packets to retransmit, with a minimal loss in the data transfer rate. This procedure prevents back end 140 from having to retransmit a complete or large section of a media object (when lost data occurs) while providing a means for receiver system 110 to accurately identify data transmission errors, without having to reassemble a complete data stream resulting in the loss of processor cycles.

At the transmission side of the broadcast architecture, back end server 140 encodes a media object into a packetized transport stream by first creating a control packet 202. Back end server 140 generates control packet 202 by assigning a value to the 4-bit counter portion of the packet's header, as shown as 0000 for counter 220. Control packet 202 also has a unique PID that identifies it as a control packet (for example, a string of 13 zeros). Back end server 140 then creates and counts a specified (predetermined) quantity of program packets 204 and 206 to create a segment of data packets of a predefined quantity (for example, there are 16 program packets in the defined segment, although any number of program segments may be selected). After counting a specified quantity, back end server 140 generates control packet 210, which has a sequentially incremented counter 225 value of 0001, defining a sequential series of control packets ex. 0000, 0001, 0010, etc., which may be identified by a unique PID (a string of 13 zeros, although other PID number schemes may be used). Back end server 140 continues this process of counting and generating control packets with a sequentially incremented counter value until a maximum value is reached due to the bit size of the counter (in this case, 1111). When this occurs, the counter value is reset to 0000 after counting the preselected quantity of program packets, thereby repeating the counting of program packets and generation of a control packet corresponding to a segment of program packets of a predefined quantity. One skilled in the art should appreciate that the present invention may be modified to work with data packets of different lengths, variable headers/payloads, and other techniques for incrementing counter values.

Receiver 110, receives the MPEG-2 based transport stream, as a satellite signal, transmitted from satellite 102 via set top box 112. Receiver 110 demultiplexes the satellite signal into a data stream, whereby the receiver checks the continuity of a transport stream by reading counters 220 and 225 of control packets 202 and 210, respectively. If receiver 110 discovers a gap between sequentially numbered control packets (for example, receiver 110 identifies counter values from control packets as 0000, 0001, 0011, whereby control packet 0010 is missing), receiver 110 informs media server 130 of the gap, via a back channel connection. For example, receiver 110 transmits a command “ERR 0010” to media server 130, which means there was a transmission error in the receipt of the data sequence identified by control packet 0010. Media server 130, upon receiving this command, informs back end server 140 of the error in the data transmission whereby back end server 140 will retransmit a data sequence of a preselected number of program packets corresponding to control packet 0010 via satellite 102. Receiver 110 may optionally identify a correctly received sequence of data packets by transmitting a command “ACK 0010”, which acknowledges that the sequence of data packets identified by control packet 0010 was received correctly.

The command structure also allows for a sequence of program packets to be acknowledged or retransmitted by following either the “ERR” or “ACK” command with two numbers. For example, the command “ERR 0100 0110” indicates to media server 130 that the data sequence of program packets identified by control packets 0100, 0101, and 0110 needs to be retransmitted. One skilled in the art may modify such commands to comport with transmission architectures that may benefit from the teachings of the present invention.

An alternative embodiment of the invention utilizes the payload data of control packet to demarcate a predetermined quantity of program packets. The payload of the control packet is used as the counter for dividing a media object into sequences of a predefined quantity of program packets. In FIG. 2B, control packet 252 is interleaved before program packets 254 and 256. After counting a sequence of program packets a predefined quantity, control packet 260 is interleaved before the next sequence of control packets of a predefined quantity.

The control packet counter 265 of control packet 252 in this embodiment exists in the payload of the control packets instead of the header, as explained above. For example, the payload of a control packet may be 144 bytes allowing for a unique counter number up to 1327104 (1152\hat{ }2), although the payload may be varied upon the requirements of the header. The control packet counter 270 of a control packet 260 is sequentially increased as a next segment of program packets of a predefined quantity is calculated and demarcated via the sequentially incremented payload of the next control packet.

At the transmission side of the broadcast architecture, back end server 140 encodes a media object into a packetized transport stream by first creating a control packet 252. Back end server 140 generates control packet 252 by assigning a value to the 1472 bit counter portion of the packet's payload, as shown as 000 . . . 0000 for counter 265. Back end server 140 then creates and counts a specified (predetermined) quantity of program packets 254 and 256 to create a segment of data packets of a predefined quantity (for example, there are 16 program packets in the defined segment, although any number of program segments may be selected). After counting a specified quantity, back end server 140 generates control packet 260, which has a sequentially incremented counter 270 value of 000 . . . 0001, defining a sequential series of control packets ex. 000 . . . 0000, 000 . . . 0001, 000 . . . 0010, etc., which may be identified by a unique PID (a string of 13 zeros, although other PID numbering schemes may be used). Back end server 140 continues sequentially incrementing the counters of control packets until a maximum value is reached due to the bit size of the counter (in this case, 111 . . . 11111, . . . representing a series of bits). When this occurs, the counter value is reset to (000 . . . 0000) after counting to a predefined quantity of program packets, thereby repeating the counting of program packets and the generation of a control packet corresponding to a segment of program packets of a predefined quantity. One skilled In the art should appreciate that the present invention may be modified to work with data packets of different lengths, variable headers/payloads, and other techniques for incrementing counter values.

Receiver 110, receives the MPEG-2 based transport stream, as a satellite signal, transmitted from satellite 102 via set top box 112. Receiver 110 demultiplexes the satellite signal into a data stream, whereby the receiver checks the continuity of a transport stream by reading counters 265 and 270 of control packets 252 and 260, respectively. If receiver 110 discovers a gap between sequentially numbered control packets (for example, receiver 110 identifies counter values from control packets as 000 . . . 0000, 000 . . . 0001, 000 . . . 0011, whereby control packet 000 . . . 0010 is missing), receiver 110 informs media server 130 of the gap, via a back channel connection. For example, receiver 110 transmits a command “ERR 000 . . . 0010” to media server 130, which means there was a transmission error In the receipt of the data sequence identified by control packet 000 . . . 0010. Media server 130, upon receiving this command, informs back end server 140 of the error in the data transmission whereby back end server 140 will retransmit a data sequence of a predetermined number of program packets corresponding to control packet 000 . . . 0010 via satellite 102. Receiver 110 may optionally identify a correctly received sequence of data packets by transmitting a command “ACK 000 . . . 0010”, which acknowledges that the sequence of data packets identified by control packet 000 . . . 0010 was received correctly.

The command structure also allows for a sequence of program packets to be acknowledged or retransmitted by following either the “ERR” or “ACK” command with two numbers. For example, the command “ERR 000 . . . 0100 000 . . . 0110” indicates to media server 130 that the data sequence of program packets identified by control packets 000 . . . 0100, 000 . . . 0101, and 000 . . . 0110 needs to be retransmitted. One skilled in the art may modify such commands to comport with transmission architectures that may benefit from the teachings of the present invention.

Also, one skilled in the art may make use of the back channel to retransmit lost sequences of data packets, if such a back channel could accommodate such transmissions. Media server 130 would transmit the sequence of missing data packets to receiver 110 through a communications network, such as PSTN 120 or an Internet connection.

Referring to FIG. 3, video signal, representing video data of a media object is provided from the source 300. This signal is coupled to a timing circuit 310 and, via a multiplexor 301, to a video signal compression apparatus 314, indicated as an MPEG compressor. The timing circuit 310 is arranged to allocate the flow of data into multiplexor 301 and MPEG compressor 314. The timing circuit 310 also provides a timing signal that is used to condition the multiplexor 301 as to pass the active portions of video signal from the source 300, to the MPEG compressor 314. This eliminates the digital data from the video signal and affords a modicum of compression efficiency to MPEG compressor 314.

MPEG compressor 314, similar to other video signal compressors, in general includes two basic components. The first component operates on the video signal and performs the actual compression of the image information signal. The second component formats the compressed signal according to a desired protocol. Typically the second component includes a controller that generates header/payload data and concatenates the header data with the compressed video data. According to the MPEG protocol, a provision is made to include different types of user data within the picture headers associated with respective video frames/fields.

In the MPEG compressor 314, a controller 312 receives timing information from timing circuit 310. The controller 312 arranges this data as user data or extension data within the frame headers and concatenates this data with the compressed video signal generated in the compressor. The compressed signal including frame or picture headers is applied to the transport processor 315. The transport processor 315 segments the compressed video data into packets of a predetermined amount of compressed data, generates packet headers which identify the video information within respective transport packets, performs error detection/correction coding and concatenates the compressed segment, error code information and packet header to form a transport packet. Additionally, transport processor 315 determines the value for the counter (either in the header and/or payload) of a control packet and counts the number of program packets before interleaving an additional control packet between program packet sequences, as to define a sequence of program packets of a specified quantity. Additionally, transport processor 315 contains a FIFO buffer that stores parsed data sequences, in case such data sequences need to be retransmitted. Transport packets are coupled to a transmitter 316 (such a satellite transmitter interface) for transmission. Communications interface 318, such as a modem or network enabled communications port, receives control commands to retransmit lost data packets and to perform other types of maintenance functions. Transport processor 315 retransmits the lost data sequences by accessing the data in its coupled FIFO buffer. For detailed information on transport packet processing the reader is referred to U.S. Pat. No. 5,168,356.

FIG. 4 illustrates exemplary receiver apparatus for reproducing compressed video signal of the type generated by the FIG. 3 circuitry. In FIG. 4 transmitted compressed video signal is captured by an antenna and input to a communications interface 400. The antenna provides baseband compressed video signal to an inverse transport processor 402. Within the inverse transport processor, transport headers are separated from compressed video payloads (MPEG formatted signal) and the transport headers and/or control packet payloads are communicated to the system controller 408 to provide system synchronization with the transmitter, and to provide information regarding damaged or lost data. When system controller 408 determines there is a missing control packet (for example, a control packet counter in the header or payload is received out of sequence), system controller 408 requests a retransmission of the missing program packets via communications interface 400 via a command. The compressed video signal is coupled to a decompressor such as a MPEG based decoder 404. The MPEG decoder internally separates MPEG header data from compressed pixel data. The header data is utilized by the decoder 404 to establish decompression parameters for decompressing the pixel data. The user data included in the compressed signal headers is extracted by the decoder and provided to the system controller 408. The system controller 408 assembles the program packets and provides them to a conventional on screen display processor 406 that processes the decompressed video signal for display. In an optional embodiment, MPEG decoder 404 and system control 408 are integrated into a common unit.

Alternative embodiments exist of the invention where the counter information may be put into picture header data, or an auxiliary data field that may be allocated for inserting predefined data. The principles of the present invention may be modified, upon the needs of one skilled in the art, as to accommodate insert counter data into the auxiliary data areas in the data layer and other spaces where user defined data entered into a data packet.

What is claimed is:

1. A method for providing a dynamic error recovery mechanism for transmitting media objects, the steps comprising the steps of:
parsing a media object into a transported stream of program packets;
inserting a control packet into said transport stream corresponding to a predefined quantity of program packets, wherein said predefined quantity of program packets defines a sequence of program packets of a predefined quantity; and
interleaving an additional control packet into said transport stream after determining an additional sequence of program packets of said predefined quantity.

2. The method of claim 1, wherein said transport stream corresponds with at least one of an MPEG-2 transport stream or a Joint Video Team compliant transport stream.

3. The method of claim 1, wherein said transport stream is transmitted over at least one of: a satellite broadcast network, a telephone network, an internet enabled connection, and a wireless connection.

4. The method of claim 1, wherein said control packet has a counter that is incremented, as to define a new sequence of program packets.

5. The method of claim 1 comprising the additional step of:
transmitting an already parsed sequence of program packets defined by a control packet, wherein said transmission is in response to a command requesting said transmission.

6. The method of claim 4, wherein said transmission of said already parsed sequence of program packets is transmitted by at least one of a satellite transmission and a back channel.

7. The method of claim 4, wherein said command is generated when a receiver determines a gap in an incremented sequence of control packets.

8. An apparatus for providing a dynamic error recovery mechanism for transmitting media objects comprising
a means for parsing a media object into a transported stream of program packets (254, 256);
a means for inserting a control packet (252) into said transport stream corresponding to a predefined quantity of program packets, wherein said predefined number of program packets (254, 256) defines a sequence of program packets of a predefined quantity; and
a means for interleaving an additional control packet (260) into said transport stream after said predefined quantity of program packets.

9. The apparatus of claim 8, wherein said transport stream corresponds with at least one of an MPEG-2 transport stream or a Joint Video Team compliant transport stream.

10. The apparatus of claim 8, wherein said transport stream is transmitted over at least one of: a satellite broadcast network, a telephone network, an internet enabled connection, and a wireless connection.

11. The apparatus of claim 8, wherein said control packet has a counter that is incremented, as to define a new sequence of program packets.

12. The apparatus of claim 8 additionally comprising:
a means for transmitting an already parsed sequence of program packets defined by a control packet, wherein said transmission is in response to a command requesting said transmission.

13. The apparatus of claim 12, wherein said transmission of said already parsed sequence of program packets is transmitted by at least one of a satellite transmission and a back channel.

14. The apparatus of claim 12, wherein said command Is generated when a receiver determines a gap in an incremented sequence of control packets.

15. A method for sequentially assigning a control packet to a plurality of MPEG-2 compliant data packets corresponding to a media object comprising the steps of:
identifying a plurality of MPEG-2 compliant data packets;
parsing said plurality of MPEG-2 compliant data packets into a plurality of program packets comprising a group of program packets of a predefined number; and
adding to said group of packets a control packet comprising an counter number that is sequentially increased.

16. The method of claim 15, wherein said counter is sequentially increased until a bit size of the counter is at a maximum, wherein said counter is reset.

17. The method of claim 15, wherein said method is repeated for a second sequence of MPEG-2 compliant packets.

18. The method of claim 15 comprising the additional step of:
transmitting an already parsed sequence of MPEG-2 compliant program packets corresponding to said control packet, wherein said transmission is in response to a command requesting said transmission.

19. The apparatus of claim 18, wherein said transmission of said already parsed sequence of MPEG-2 compliant program packets is transmitted by at least one of a satellite transmission and a back channel.

20. An apparatus for sequentially assigning a control packet to a plurality of MPEG-2 compliant program packets corresponding to a media object, comprising:
a means for identifying said a MPEG-2 compliant data stream;
a means for parsing said MPEG-2 compliant data stream into a plurality of program packets (254, 256) comprising a group of program packets of a predefined number; and
a means for adding to said group of program packets (254,256) a control packet (252) comprising a counter number that is sequentially increased, wherein said counter number is sequentially increased.

21. An apparatus for determining transmission errors in a broadcast architecture comprising:
a means for receiving a packetized transport stream comprising control packets (252, 260) and program packets (254, 256), wherein said control packets (252, 260) correspond to a sequence of program packets of a predetermined quantity;
a means for determining a sequential series of received control packets (252, 260); and
a means for requesting a sequence of program packets (254, 256) corresponding to a control packet missing (252) from said sequential series.

22. The apparatus of claim 21, further comprising:
a means for requesting said sequence of program packets corresponding to said missing control packet.

23. The apparatus of claim 22, further comprising
a means for receiving said requested sequence of program packets corresponding to said missing control packet.
